(19) United States
(12) Patent Application Publication
(10) Pub. No.: US 2022/0390251 A1
(43) Pub. Date: Dec. 8, 2022

(54) INFORMATION PROCESSING APPARATUS AND VEHICLE

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 17/664,504

(22) Filed: May 23, 2022

(30) Foreign Application Priority Data
Jun. 4, 2021 (JP) 2021-094504

(51) Int. Cl. G01C 21/36; G08G 1/005

(52) U.S. Cl. CPC G01C 21/3647; G08G 1/005; B60Q 1/04

(57) ABSTRACT

An information processing apparatus comprises a storage configured to store navigation-related information; and a controller configured to execute: predicting a course of a vehicle based on at least the navigation-related information, and projecting a first image related to the predicted course onto a road surface located in front of the vehicle.

### CROSS REFERENCE TO THE RELATED APPLICATION

This application claims the benefit of Japanese Patent Application No. 2021-094504, filed on Jun. 4, 2021, which is hereby incorporated by reference herein in its entirety.

### BACKGROUND

### Technical Field

The present disclosure relates to vehicle safety.

### Description of the Related Art

There has been known technology for transmission of the intentions of a vehicle's driver to pedestrians.

Japanese Patent Laid-Open No. H7-246876, for example, discloses a system that uses LED lamps to convey intentions to pedestrians and vehicles that are diagonally in front of the vehicle.

### SUMMARY

An object of the present disclosure is to reveal information on the course of a vehicle to those around it.

The present disclosure in its one aspect provides an information processing apparatus comprising a storage configured to store navigation-related information; and a controller configured to execute: predicting a course of a vehicle based on at least the navigation-related information, and projecting a first image related to the predicted course onto a road surface located in front of the vehicle.

The present disclosure in its another aspect provides a vehicle comprising: a projector configured to project an image on a road surface located in front of the vehicle; a storage configured to store navigation-related information; and a controller configured to execute: predicting a course of a vehicle based on at least the navigation-related information, and projecting a first image related to the predicted course through the projector.

Another aspect of the present disclosure is a program for causing a computer to perform a method performed by the aforementioned information processing apparatus, or a computer-readable non-transitory memory medium storing the program.

The present disclosure makes it possible to reveal information on the course of a vehicle to those around it.

### BRIEF DESCRIPTION OF THE DRAWINGS

FIG. 1 is a diagram for explaining the overview of a vehicle system;

FIG. 2 is a diagram for explaining the configuration of an in-vehicle device, projector, and sensor group;

FIG. 3A is a diagram for explaining projection of an image by a projector;

FIG. 3B is a diagram for explaining projection of an image by the projector;

FIG. 3C is a diagram for explaining projection of an image by the projector;

FIG. 3D is a diagram for explaining projection of an image by the projector;

FIG. 4 is an example of image data stored in the in-vehicle device;

FIG. 5 is a flowchart of processing performed by the in-vehicle device in a first embodiment;

FIG. 6 is a flowchart of processing performed by the in-vehicle device in the first embodiment;

FIG. 7A is a diagram for explaining rotation correction of a guide image;

FIG. 7B is a diagram for explaining rotation correction of a guide image;

FIG. 8 is a diagram for explaining the configuration of a vehicle system in a variation of the first embodiment;

FIG. 9 is a diagram for explaining the configuration of a vehicle system in a second embodiment;

FIG. 10 is a flowchart of processing performed by the in-vehicle device in the second embodiment;

FIG. 11A is an example of images presented to a pedestrian in the second embodiment;

FIG. 11B is an example of images presented to a pedestrian in the second embodiment;

FIG. 12A is an example of images presented to an oncoming vehicle in a variation of the second embodiment;

FIG. 12B is an example of images presented to an oncoming vehicle in a variation of the second embodiment; and

FIG. 13 is an example of an image projected onto a road surface in the variation.

### DESCRIPTION OF THE EMBODIMENTS

An information processing apparatus according to an aspect of the present disclosure includes: a storage configured to store navigation-related information; and a controller configured to execute predicting a course of a vehicle based on at least the navigation-related information, and projecting a first image related to the predicted course onto a road surface located in front of the vehicle.

Navigation-related information is information used to navigate the driver of a vehicle. The navigation-related information may be road map information, a planned course (path) of the vehicle, or the like. The controller predicts the course (path) of the vehicle (in particular, a change in the direction of travel of the vehicle, e.g., a right turn or left turn of the vehicle at, for example, an intersection) based at least on the navigation-related information. The prediction of the course may be performed by using driving-related information (e.g., the speed of the vehicle, information on the blinker status of the vehicle).

The controller also projects a first image related to the predicted course onto the road surface located in front of the vehicle. The first image is typically an image that visually indicates the course (direction of travel) of the vehicle, such as an arrow. The image may also include text and icons.

This makes it possible, for example, to project an image on the road surface to inform that the vehicle is going to make a right turn or left turn at an intersection, and to efficiently convey information on the behavior of the vehicle to the outside of the vehicle.

The projection can be performed, for example, by using an adaptive headlight unit mounted on the vehicle. An adaptive headlight unit is a headlight unit capable of projecting light through digital light processing (DLP). The unit incorporates a mirror device, such as a movable micro-mirror array, that can project light on pixel basis.

Specific embodiments of the present disclosure will now be described with reference to the attached drawings. The hardware configuration, module configuration, functional configuration, and the like described in each embodiment are not intended to limit the technical scope of the disclosure to those alone, unless otherwise stated.

### First Embodiment

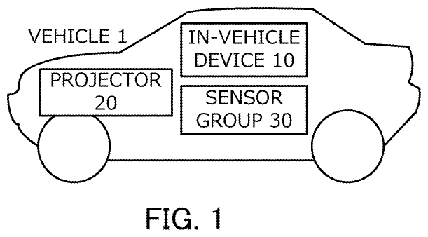

An overview of a vehicle system according to the first embodiment will now be described with reference to FIG. 1. The vehicle system according to this embodiment includes an in-vehicle device 10, a projector 20, and a sensor group 30 mounted on a vehicle 1.

The vehicle 1 is a vehicle capable of projecting any image onto a road surface through a projector 20 that also serves as a front light.

The projector 20 is a headlight unit included in the vehicle 1, and is a device capable of projecting light by digital light processing. Digital light processing is technology for irradiating with light on pixel basis by controlling multiple micro-mirrors. The projector 20 functions as a front light of the vehicle 1 and also has the function of projecting any image onto a road surface. The projector 20 is also called “adaptive headlight unit”.

The in-vehicle device 10 is a device that controls the projection of images by the projector 20. The in-vehicle device 10 may be an electronic controller that controls the components of the vehicle 1, or a device that also serves as a car navigation device, display audio device, or the like.

In this embodiment, the in-vehicle device 10 predicts the course of the vehicle (vehicle 1) and, only if it predicts that the vehicle will make a right or left turn within a predetermined period of time, generates an image (first image) for informing the others about this fact. The generated image may be, for example, an arrow or other graphics indicating the course of the vehicle 1. The in-vehicle device 10 transmits the generated image to the projector 20 and projects the image onto a road surface.

As a result, the course of the vehicle 1 (e.g., the fact that the vehicle 1 is going to make a right or left turn) can be visually conveyed to pedestrians and others located in the vicinity of the vehicle 1.

In the following description, the image used to guide the course of the vehicle 1 will be referred to as “guide image”.

The sensor group 30 is a set of multiple sensors included in the vehicle 1. In this embodiment, the in-vehicle device 10 uses the data output by the sensors in the sensor group 30 (hereinafter referred to as “sensor data”) to predict the course of the vehicle.

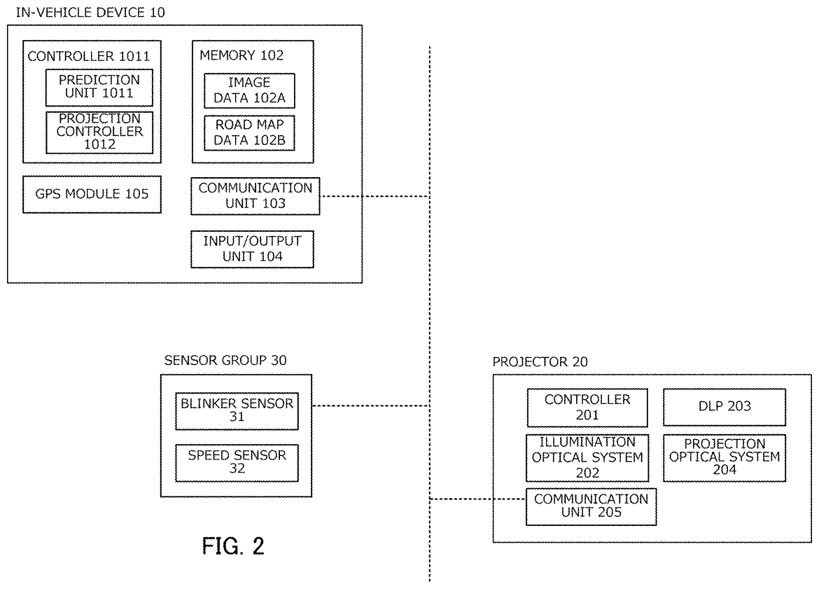

FIG. 2 is a diagram illustrating in more detail the components of the in-vehicle device 10, the projector 20, and the sensor group 30 included in the vehicle system according to this embodiment. The components are connected to each other via a bus for the in-vehicle network.

First, the projector 20 will be described.

The projector 20 is a headlight unit included in the vehicle 1. The projector 20 is also called “adaptive headlight unit”. The projector 20 includes a controller 201, an illumination optical system 202, a DLP 203, a projection optical system 204, and a communication unit 205.

The projector 20 functions as a front light and also has the function of projecting any image onto a road surface by digital light processing.

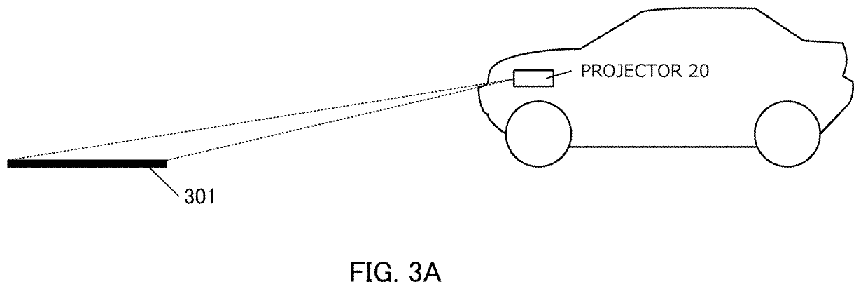

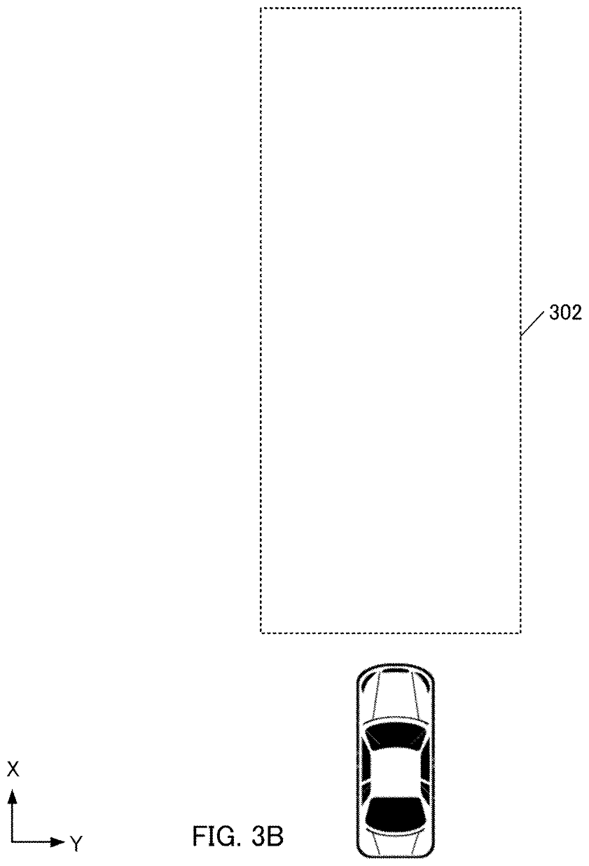

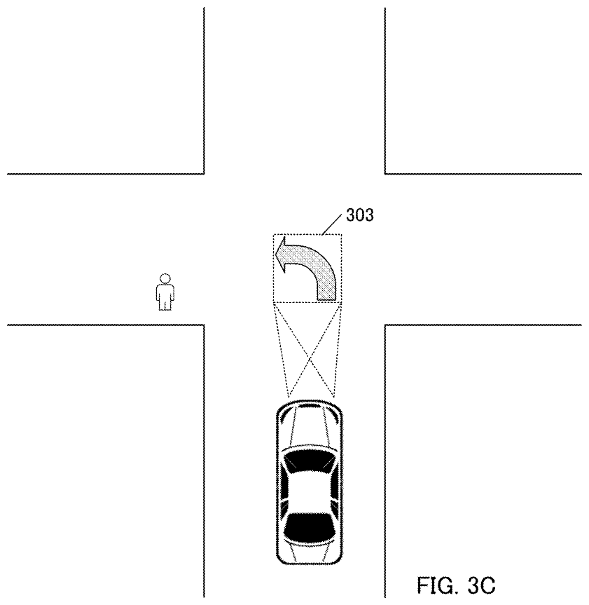

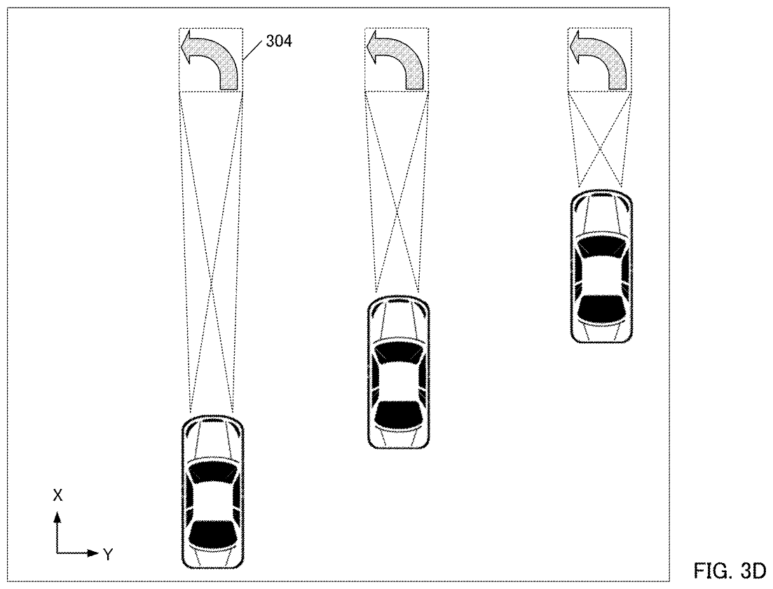

FIG. 3A is a schematic view illustrating the positional relationship between the vehicle 1 and the road surface, from the side of the vehicle. As illustrated in the drawing, the projector 20 is capable of projecting a guide image onto the road surface located in front of the vehicle 1. The reference numeral 301 indicates the position where the guide image is projected.

The projector 20 is configured to change the angle of irradiation with light, thereby changing the position where the image is projected within a predetermined area. FIG. 3B is a diagram for explaining the area (reference numeral 302) onto which the guide image can be projected. The projector 20 is configured to be able to adjust the pitch angle and yaw angle as the angle of irradiation with light, which enables an image to be projected onto any position on the XY plane.

For example, at the time when the vehicle 1 enters an intersection, the projector 20 determines an arbitrary point in the intersection as a point onto which a guide image is to be projected, and projects the guide image onto the point. FIG. 3C is a schematic view of the positional relationship between the vehicle 1 and the road surface viewed from the vertical direction. The reference numeral 303 indicates the point onto which the guide image showing the course of the vehicle 1 is projected.

Dynamically changing the angle of irradiation with light allows the projection position of the image to be fixed even when the vehicle 1 is moving. FIG. 3D is a diagram illustrating an example case in which the position where the guide image is projected is fixed at the point indicated by the reference numeral 304. For example, calculating the angle of irradiation with light based on the positional relationship between the vehicle 1 and the projection point 304 and dynamically changing the angle of irradiation enables control so that the guide image can be kept being projected onto a predetermined point even if the vehicle 1 moves. For example, if the projector 20 is capable of projecting an image up to 30 meters away, it can start projecting the guide image at the time when the vehicle 1 approaches up to 30 meters in front of the intersection, and continue projecting the guide image onto the same point until the vehicle 1 passes.

The controller 201 is an arithmetic device that controls light irradiation. The controller 201 can be an arithmetic processing device such as a central processing unit (CPU) or an electric control unit (ECU). The controller 201 may be a one-chip computer or the like that includes a memory (main memory and auxiliary memory).

The projector 20 is configured to be switchable between a first mode in which normal headlight illumination is performed and a second mode in which a guide image is projected onto a road surface.

The controller 201 normally operates the projector 20 in the first mode, and upon reception of an instruction to project a guide image from the in-vehicle device 10, switches it to the second mode. In the second mode, the projection is controlled based on the data received from the in-vehicle device 10. Upon reception of an instruction from the in-vehicle device 10 to terminate the projection of the guide image, the controller 201 switches it to the first mode.

The illumination optical system 202 is a system that generates light for projecting an image and includes a light source. The light source is, for example, a high-pressure mercury lamp, a xenon lamp, an LED light source, or a laser light source. The light generated by the light source enters the DLP 203 through an optical system such as mirrors and lenses.

The digital light processing unit (DLP) 203 is a unit that performs digital light processing. The DLP 203 includes multiple micro-mirror devices (digital mirror devices) arranged in an array. Regarding the DLP 203, controlling the tilt angle of each micro-mirror creates, on pixel basis, portions of the road surface that are irradiated with light and portions that are not. In addition, regarding the DLP 203, controlling the operation time of each mirror by pulse-width modulation (PWM) creates contrast between pixels. In other words, the DLP 203 functions as a display device that modulates light to produce images.

The projection optical system 204 includes an optical system (lens and mirrors) for image projection.

The communication unit 205 is an interface unit that connects the projector 20 to an in-vehicle network. The communication unit 205 executes processing for transmitting messages generated by the controller 201 to the in-vehicle network and processing for transmitting messages received from the in-vehicle network to the controller 201.

The in-vehicle device 10 will now be described.

The in-vehicle device 10 is a device that controls the projection of guide images by the projector 20. The in-vehicle device 10 may be an electronic controller (ECU) that controls the components of the vehicle 1, or may be a device that also serves as a car navigation device, a display audio device, and the like.

The in-vehicle device 10 includes a controller 101, a storage 102, a communication unit 103, an input/output unit 104, and a GPS module 105.

The controller 101 is an arithmetic device that controls the control performed by the in-vehicle device 10. The controller 101 can be an arithmetic processing device such as a CPU.

The controller 101 includes two functional modules: a prediction unit 1011 and a projection controller 1012. Each functional module may be implemented by executing a stored program in the CPU.

The prediction unit 1011 predicts the course of the vehicle and predicts that the direction of travel of the vehicle will change (e.g., a right or left turn will occur) within a predetermined period of time.

To be specific, the prediction unit 1011 uses the position information received from a GPS module 105 and the road map data recorded in a road map data 102B and determines, for example, that the vehicle is approaching an intersection. Furthermore, it predicts that the vehicle will make a right or left turn at the intersection based on the sensor data acquired from a blinker sensor 31 and a speed sensor 32 which will be described below.

Although the prediction unit 1011 typically predicts that the vehicle will make a right or left turn at an intersection, it may also predict other changes in the course or direction of travel. For example, it may predict a change in the direction of travel of the vehicle at a road junction. In the following description, the term “right or left turn” can be replaced by “change in direction of travel (course)”.

The projection controller 1012 determines the image to be projected based on the results of the prediction made by the prediction unit 1011 and controls the projector 20.

To be specific, when it is predicted that the vehicle will make a right or left turn at an intersection or the like, the projection controller 1012 extracts a guide image suitable for that direction from the image data 102A and projects the guide image through the projector 20. The specific processing will be explained below.

The storage 102 includes a main memory and an auxiliary memory. The main memory is a memory in which programs to be executed by the controller 101 or data to be used for the control program is expanded. The auxiliary memory stores programs to be executed by the controller 101 or data to be used for the control program.

In addition, the storage 102 stores image data 102A and road map data 102B.

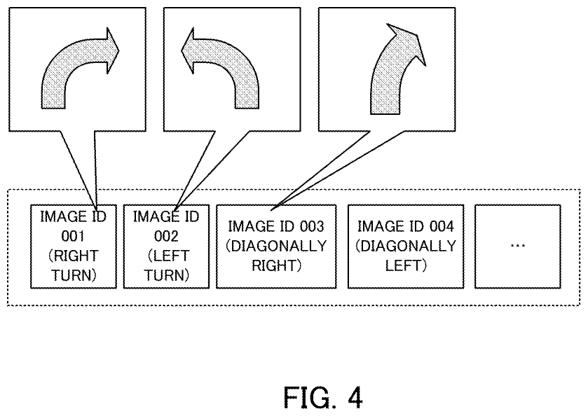

The image data 102A is a guide image projected by the projector 20, i.e., a set of images for notifying the course of the vehicle 1 to others. FIG. 4 is an example of image data 102A. In this example, multiple images that differ depending on the course taken by the vehicle 1, such as “turning right,” “turning left,” “going in a right diagonal direction,” “going in a left diagonal direction,” or the like, are stored. The images may be binary images, grayscale images, color images, and the like.

The road map data 102B is a database in which data related to the road network is stored. The road map data 102B stores definitions of multiple road segments and positional information and connection relationships for each road segment.

Each piece of the aforementioned data may be constructed when a program in a database management system (DBMS) executed by a processor manages the data stored in the memory. In this case, each piece of data may be, for example, a relational database.

The communication unit 103 is a communication interface for connecting the in-vehicle device 10 to the in-vehicle network.

The input/output unit 104 is a unit configured to accept input operations performed by the user and present information to the user. To be specific, it consists of a touch panel and its controller, and a liquid crystal display and its controller. The touch panel and liquid crystal display in this embodiment consist of a single touch panel display. The input/output unit 104 may also have a speaker or the like for outputting audio.

The GPS module 105 is a module for determining positional information based on positioning signals transmitted from positioning satellites (also referred to as GNSS satellites). The GPS module 105 may include an antenna to receive positioning signals.

The sensor group 30 is a set of multiple sensors included in the vehicle 1.

In this embodiment, the sensor group 30 includes a blinker sensor 31 and a speed sensor 32. The blinker sensor 31 is a sensor that outputs the operational status (e.g., “left,” “right,” or “off”) of the blinkers of the vehicle 1. The speed sensor 32 outputs data indicating the speed of the vehicle 1.

Note that each sensor may be directly connected to the in-vehicle network, or may be connected to the ECU that has jurisdiction over the components of the vehicle 1 (e.g., body ECU).

The components illustrated in FIG. 2 are connected to the bus of the in-vehicle network. The bus can be, for example, a CAN bus. The CAN bus is a communication bus that constitutes an in-vehicle network based on the controller area network (CAN) protocol. Although a single communication bus is illustrated in this example, the in-vehicle network may have multiple communication buses. Also, a gateway that interconnects these multiple communication buses may be included.

The details of the processing executed in the devices included in the vehicle system will now be described.

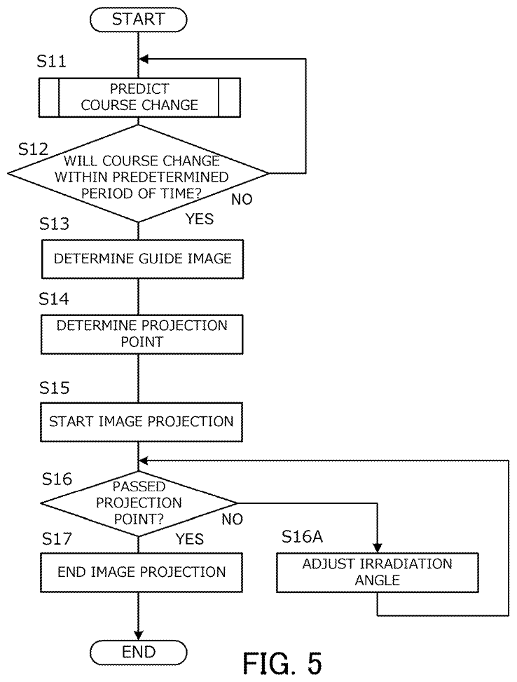

FIG. 5 is a flowchart of the processing executed in the in-vehicle device 10. The processing illustrated in FIG. 5 is repeatedly executed while the vehicle 1 is moving.

First, in Step S11, the prediction unit 1011 predicts whether or not the course of the vehicle will change within a predetermined period of time. In this embodiment, a right or left turn is illustrated as a course change.

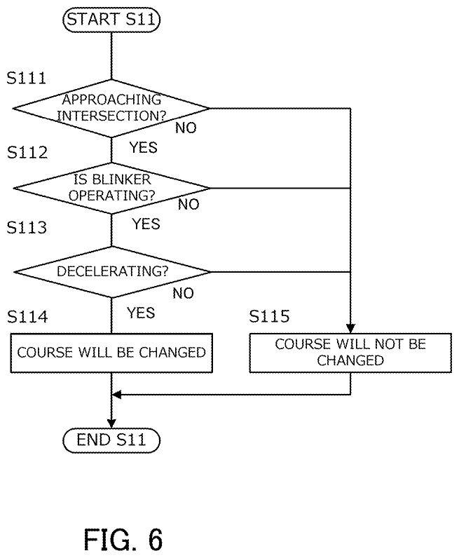

FIG. 6 is a flowchart illustrating the details of the processing executed in Step S11.

First, in Step S111, whether or not the vehicle is approaching an intersection is determined. In this step, based on the positional information acquired from the GPS module 105 and the road map data 102B, whether or not the vehicle is approaching an intersection is determined. For example, if the current position of the vehicle is within a predetermined area centered on the intersection (e.g., within a circle with a radius of 30 m), a positive determination is made in this step. If a positive determination is made in this step, the processing proceeds to Step S112. If a negative determination is made in this step, the processing proceeds to Step S115.

Next, in Step S112, whether or not the blinker of the vehicle is operating is determined. In this step, the prediction unit 1011 determines whether or not the blinker of the vehicle is operating, based on the information acquired from the blinker sensor 31. If a positive determination is made in this step, the processing proceeds to Step S113. If a negative determination is made in this step, the processing proceeds to Step S115.

In Step S113, whether or not the vehicle is decelerating is determined. In this step, the prediction unit 1011 determines whether or not whether or not the vehicle is decelerating, based on the information acquired from the speed sensor 32. For example, if it is determined that the vehicle can sufficiently decelerate before reaching the intersection according to a comparison between the distance to the intersection and the speed of the vehicle determines, a positive determination is made in this step. In contrast, if it is determined that the vehicle cannot decelerate sufficiently before reaching the intersection, a negative determination is made in this step. If a positive determination is made in this step, the processing proceeds to Step S114. If a negative determination is made in this step, the processing proceeds to Step S115.

In Step S114, as a result of the execution of Step S11, the prediction result stating “the course of the vehicle 1 will change within a predetermined period of time” is generated. In Step S115, as a result of the execution of Step S11, the prediction result stating “the course of the vehicle 1 will not change within a predetermined period of time” is generated.

Although whether or not the vehicle 1 will make a right or left turn is predicted in Step S11 in this example, the target to be predicted is not limited to right or left turns as long as it involves a course change.

The explanation will be continued referring back to FIG. 5.

In Step S12, the result of the prediction in Step S11 is determined.

If a course change is predicted within a predetermined period of time, the processing proceeds to Step S13. If no course change is predicted within the predetermined period of the time, the processing returns to the initial state.

In Step S13, the projection controller 1012 selects a guide image to be projected onto a road surface by the projector 20. For example, if the vehicle 1 is predicted to turn left in Step S11, the guide image corresponding to “turning left” is selected. The association of images may be stored in advance in the storage 102. In the case where a direction of travel other than right or left turns (e.g., “diagonal right direction”) is defined, the corresponding image may be selected in this step.

Next, in Step S14, the projection controller 1012 determines the point onto which the guide image is to be projected (hereinafter referred to as “projection point”). For example, if a right or left turn is predicted to occur at an intersection, the projection controller 1012 determines a point inside the intersection (where the roads intersect) as the projection point. The projection point is preferably a point that is easily visible to pedestrians and other vehicles.

In Step S15, the projection controller 1012 sends the guide image to the projector 20. This step allows the selected guide image to be projected onto a predetermined projection point.

In Step S16, the projection controller 1012 determines whether the vehicle 1 has passed the projection point. This determination may be made based on the positional information acquired from the GPS module 105 or the travel distance obtained by integrating the speed (vehicle speed) acquired from the speed sensor 32. If the vehicle 1 has passed the projection point, the processing proceeds to Step S17. If the vehicle 1 has not passed the projection point, the processing proceeds to Step S16A.

In Step S16A, the angle of irradiation of the road surface with light is adjusted. To be specific, the projection controller 1012 calculates the angle of irradiation with light based on the positional relationship between the vehicle 1 and the projection point that was determined in Step S14, and transmits the calculated angle of irradiation to the projector 20 (controller 201). The controller 201 controls the projection of light based on the received angle of irradiation. Repeating this process allows the guide image to be kept being projected onto the same projection point.

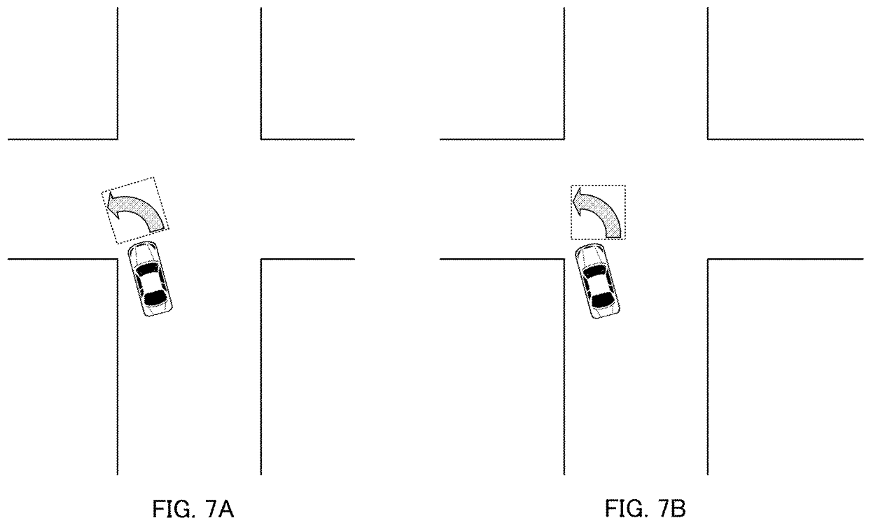

When the vehicle 1 starts operating for a right or left turn within an intersection, the direction of the guide image may change along with the direction of the vehicle body as illustrated in FIG. 7A. To prevent this, the projection controller 1012 may detect the direction of the vehicle body and make corrections by rotating the guide image based on the results of the detection. FIG. 7B illustrates an example of the guide image after the angle is corrected. For example, the projection controller 1012 can acquire the angle of steering (rudder angle) and changes in the vehicle's azimuth angle, and make corrections by rotating the guide image based on these pieces of information.

In Step S17, the projection controller 1012 sends an instruction to terminate the projection of the guide image, to the projector 20 (controller 201). This terminates the projection of the guide image by the projector 20.

As described above, with the vehicle system according to the first embodiment, in the case where a change in the direction of travel is predicted for a moving vehicle, the projector projects an image visually indicating the change onto a road surface. This makes it possible to efficiently convey information on the course of the vehicle to pedestrians and others located in the vicinity of the vehicle 1, as illustrated in FIG. 3B.

Although an image including a block-shaped arrow is illustrated as a guide image indicating the direction of travel of the vehicle in the first embodiment, the guide image may be other than this. The guide image may, for example, include text or an icon to give a warning. The guide image may also be animated, for example, by blinking. For example, a graphic can be animated in such a way that it extends in the direction of travel. In this case, the image data 102A may include data related to the animation.

### Modification 1 of First Embodiment

In the first embodiment, it is predicted that the vehicle will make a right or left turn based on the road map data and the operational status of the blinker of the vehicle 1. Meanwhile, if the course of the vehicle is known, for example, because the vehicle 1 is equipped with a navigation device, information on the course may be used to predict that the vehicle will make a right or left turn.

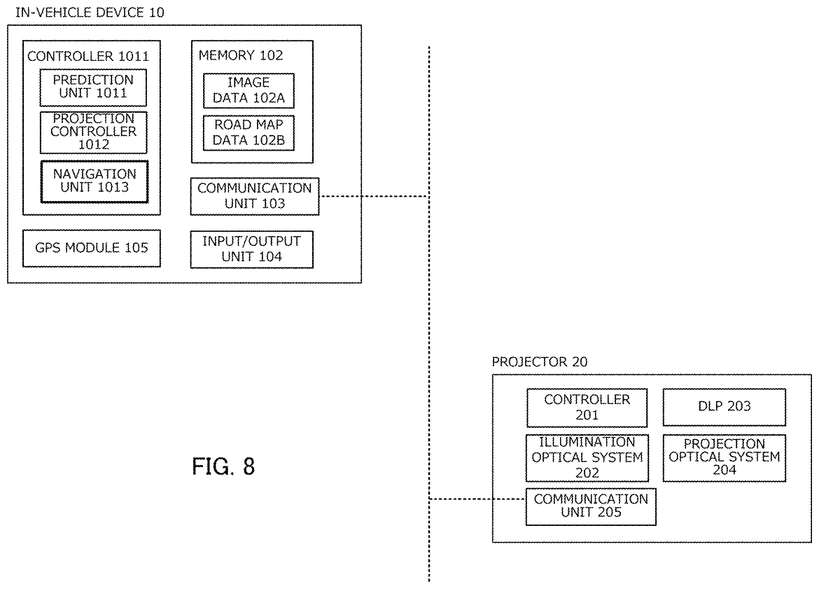

FIG. 8 is a diagram illustrating the details of components included in a vehicle system according to a modification of the first embodiment. In the in-vehicle device 10 according to this modification differs from that in the first embodiment in that the controller 101 further includes a navigation unit 1013. It also differs from that in the first embodiment in that the vehicle 1 does not include a sensor group 30.

The navigation unit 1013 provides a navigation function to the occupants of the vehicle. To be specific, it searches for and navigates courses to the destination based on the road map data 102B stored in the storage 102 and the positional information acquired by the GPS module 105. The navigation unit 1013 may be configured to be communicable with the GPS module 105. The navigation unit 1013 may also have a unit (such as a communication module) for acquiring traffic information from outside.

In this modification, the navigation unit 1013 provides the prediction unit 1011 with information on the course of the vehicle 1. The information on the course is, for example, information on the road segments to be traversed between the starting point and the destination, and the intersections to be traversed.

In Step S11, the prediction unit 1011 identifies the intersection where a right or left turn will occur, based on the provided information.

In this way, the point at which the vehicle will make a right or left turn may be identified based on information other than the sensor information.

Although an example was given in which a navigation device or the like mounted on the vehicle 1 provides course information in this modification, if the vehicle 1 is an autonomous vehicle or a semi-autonomous vehicle, course information may be acquired from a device that controls the driving of the vehicle.

### Second Embodiment

In the first embodiment, when the vehicle 1 makes a right or left turn, the guide image is projected onto a road surface. In contrast, the second embodiment detects the presence or absence of a pedestrian crossing the course of the vehicle 1 and outputs an image containing a message for the pedestrian (hereinafter referred to as “message image” and corresponding to the second image in the present disclosure) simultaneously with the guide image.

The message image is an image for conveying the intentions of the driver of the vehicle 1, such as “the vehicle is pausing,” “giving way to pedestrians,” or “giving way” to pedestrians and others. The message image does not necessarily have to contain text, as long as it can convey the driver's intention.

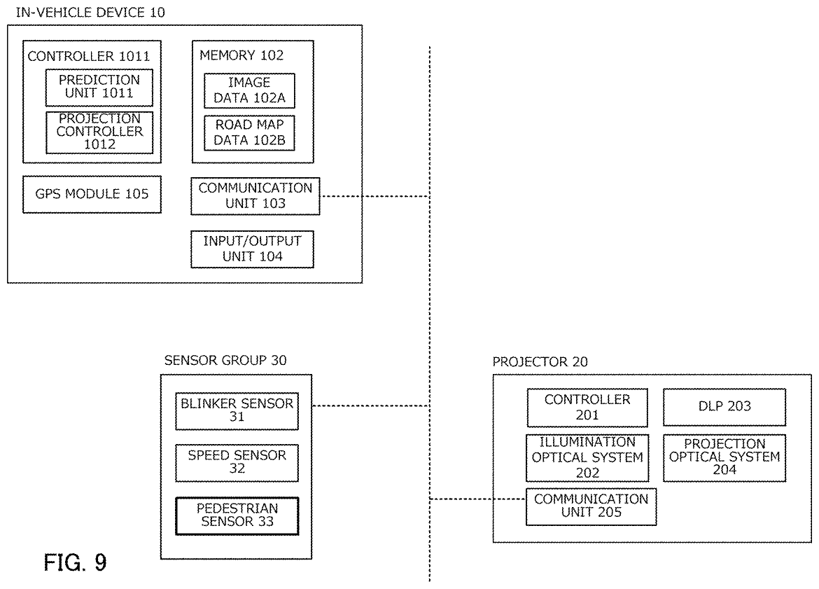

FIG. 9 is a diagram illustrating the details of the components included in the vehicle system of the second embodiment. The vehicle 1 according to this embodiment differs from that in the first embodiment in that it further includes a pedestrian sensor 33. It also differs from the first embodiment in that the projection controller 1012 performs processing for adding a message image to the guide image based on the detection result related to the pedestrian.

The pedestrian sensor 33 is a sensor that detects pedestrians in the vicinity of the vehicle 1. To be specific, when it detects a person in front of the vehicle 1, it outputs information on the location of the person as sensor data. The pedestrian sensor 33 may be an image sensor, a stereo camera, or the like, for example. The objects to be detected by the pedestrian sensor 33 may include light vehicles such as bicycles.

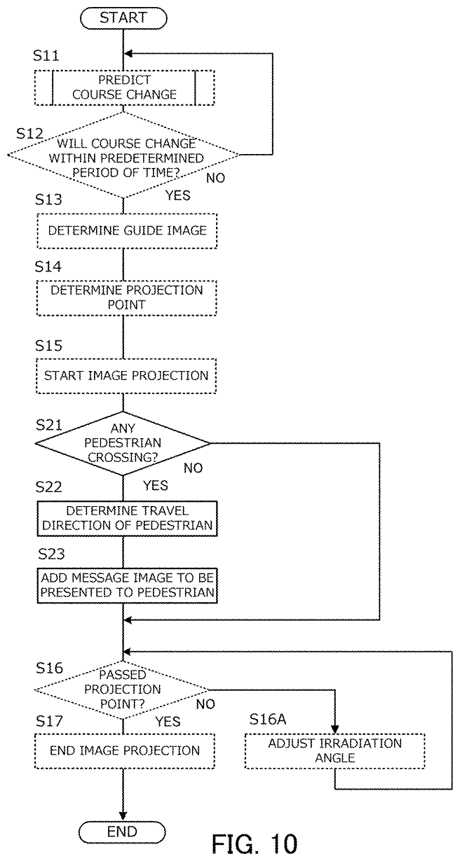

FIG. 10 is a flowchart illustrating processing executed in the in-vehicle device 10 in the second embodiment. The same processing as in the first embodiment is indicated by dotted lines and the related explanation will be omitted.

In this embodiment, after the projection of the guide image is started, the processing for adding a message image directed at pedestrians is executed in Steps S21 to S23.

In Step S21, the projection controller 1012 determines the presence of a pedestrian crossing the course of the vehicle based on the sensor data acquired from the pedestrian sensor 33. In this step, a positive determination is made when all of the following conditions are met.
(1) The vehicle 1 is located within an intersection including a crosswalk.

Whether or not the intersection includes a crosswalk can be determined, for example, based on the road map data 102B.
(2) The vehicle 1 is in the middle of a right or left turn.

For example, whether or not the vehicle is in the middle of a right or left turn can be determined based on the sensor data output from the blinker sensor 31.
(3) The pedestrian sensor 33 has detected a crossing pedestrian.

For example, if the detected pedestrian is located in the roadway or is traveling from the sidewalk toward the roadway, the pedestrian can be determined as a crossing pedestrian.

If a positive determination is made in this step, the processing proceeds to Step S22. If a negative determination is made in this step, the processing proceeds to Step S16.

In Step S22, the projection controller 1012 determines the direction of travel of the pedestrian. For example, if the road map data 102B includes information on the location of a crosswalk, it can be estimated that the pedestrian is traveling along the crosswalk. In addition, the direction of travel of the pedestrian may also be determined by tracking changes in the pedestrian's location based on sensor data periodically acquired from the pedestrian sensor 33.

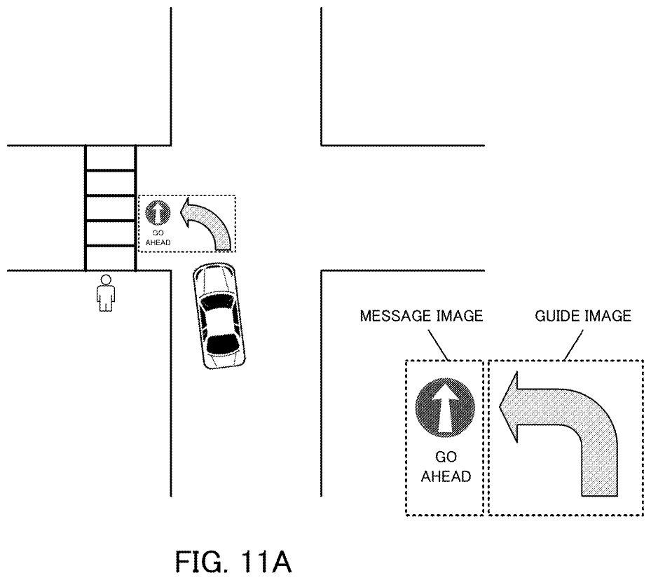

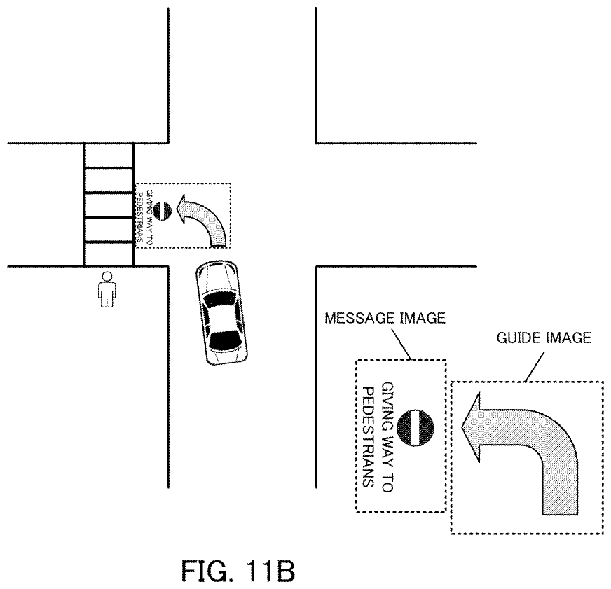

Next, in Step S23, the projection controller 1012 adds a message image to be presented to the pedestrian to the guide image being projected. FIG. 11A and FIG. 11B illustrate examples of message images directed at the pedestrian.

FIG. 11A illustrates an example case where a message image to encourage the pedestrian to cross is added to the guide image being projected. The message image is oriented to face the pedestrian. With this configuration, pedestrians trying to cross can easily recognize the message.

FIG. 11B illustrates an example case where a message image stating that the vehicle 1 will pause is added to the guide image being projected. The message is oriented parallel to the direction of travel of the pedestrian. This configuration makes it possible for pedestrians to recognize the message regardless of their directions of travel (directions in which they cross).

In Step S23, it is preferable to make the driver of the vehicle aware that the message image is going to be projected. For this reason, the in-vehicle device 10 may notify the driver by sound or other means that there is a pedestrian who should be given way (that the driver should pause). When the driver responds to the notification (e.g., by stopping the vehicle), the output of a message image may be started.

The processing after Step S16 is the same as in the first embodiment.

In the second embodiment, the projection positions of both the guide image and the message image are adjusted in Step S16A. This allows the two types of images to be projected onto a fixed position.

According to the second embodiment, upon detection of a pedestrian crossing, a message directed at the pedestrian can be output, allowing intentions to be conveyed more reliably.

Although the message to the pedestrian is output in text in this embodiment, the message image does not necessarily have to include text. For example, intentions to give way can also be expressed by adding graphics, icons, and the like to guide images.

Aside from that, although the sensor data acquired from the blinker sensor 31 and the pedestrian sensor 33 are used to detect pedestrians crossing the course of the vehicle 1 in this embodiment, the presence or absence of pedestrians crossing the course of the vehicle 1 may be detected also by using other sensors. For example, the steering angle of the vehicle 1 acquired from the steering sensor may be used to determine whether or not the course of the pedestrian and the course of the vehicle 1 intersect.

### Modification of Second Embodiment

The second embodiment has shown an example case where the presence or absence of a pedestrian crossing the course of the vehicle 1 is detected and a message is presented to the pedestrian. Meanwhile, the target to be presented with such a message is not limited to pedestrians. For example, the presence or absence of other vehicles intersecting the course of the vehicle 1 may be detected, and a message image to be presented to the other vehicles may be generated.

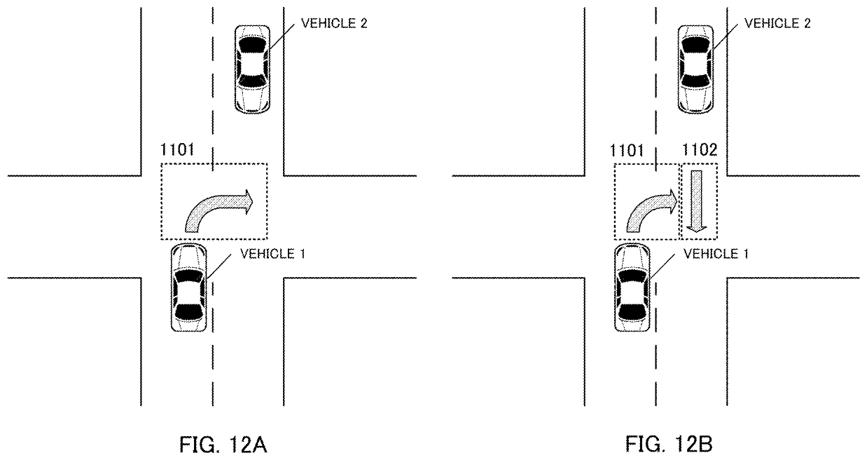

FIG. 12A and 12B illustrate the positional relationship between the vehicle 1 and the vehicle 2 that intersects the course of the vehicle 1.

The vehicle 1 is a vehicle waiting to cross the oncoming lane, and the vehicle 2 is a vehicle traveling in the oncoming lane. In such a case, as illustrated in FIG. 12A, if the vehicle 1 projects a guide image 1101 showing its course, it may interfere with the vehicle 2 traveling in the opposite direction.

For this reason, when detecting another vehicle intersecting the course of the vehicle, the vehicle 1 adds a message image 1102 directed at the other vehicle to the guide image 1101 as illustrated in FIG. 12B. In the example illustrated in the drawing, the message image expressing an intention to give way to the oncoming traffic is added to the guide image.

Other vehicles intersecting the course of the vehicle can be detected by a sensor that is similar to the pedestrian sensor 33 but detects vehicles. The sensor may be an image sensor, a stereo camera, or the like.

According to this modification, other vehicles that intersect the course of the vehicle can be informed of the course of the vehicle and a message can be conveyed to the other vehicles.

(Modification)

The aforementioned embodiments are merely illustrative, and the present disclosure may be implemented with appropriate changes without departing from its spirit.

For example, the processing and units described in the present disclosure may be implemented in any combination as long as no technical inconsistency occurs.

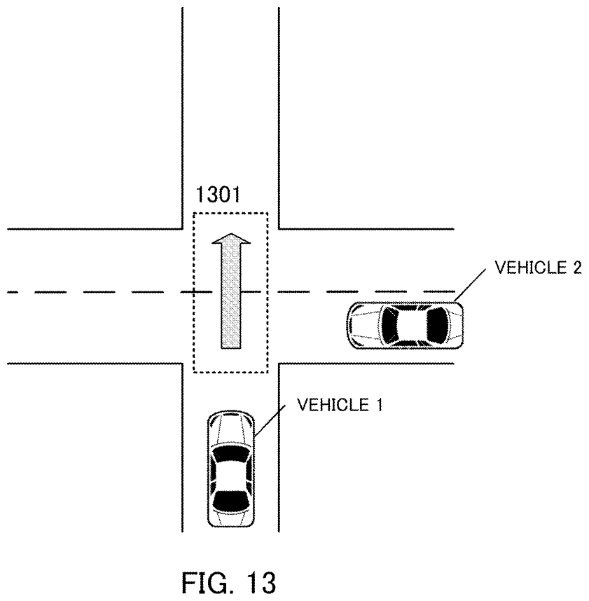

In the description of the embodiments, the projection of the guide image is triggered by a change in the course of the vehicle; however, the projection of the guide image does not necessarily have to be triggered by a change in the course. For example, as illustrated in FIG. 13, when the vehicle 1 is crossing an intersection, the vehicle 1 can alert vehicles traveling into the intersection by projecting its course (reference numeral 1301) on the road surface. In this case, depending on the operational status of the blinker of the vehicle 1, the guide images corresponding to “turning left,” “going straight,” and “turning right” may be projected on the road surface.

In the example shown in the drawing, the projection of the guide image is triggered by passage of the vehicle 1 through a point where there is a high risk of collision with an incoming vehicle.

Also, the projection controller 1012 may determine whether there is an obstacle to the projection of the guide image, and stop the projection of the guide image if there is an obstacle to the projection of the guide image. For example, if there is a vehicle in front of the vehicle 1 and the guide image cannot be projected, the projection of the guide image may be temporarily stopped. Whether or not there is an obstacle to the projection of the guide image may be determined based on the sensor data output by the sensors of the vehicle 1.

In addition, the processing described as being performed by one device may be shared and executed by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include: any type of disk such as a magnetic disk (floppy (registered trademark) disk, hard disk drive (HDD), etc.), an optical disk (CD-ROM, DVD disk, Blu-ray disk, etc.); and any type of medium suitable for storing electronic instructions, such as read-only memory (ROM), random access memory (RAM), EPROM, EEPROM, magnetic cards, flash memory, and optical cards.

What is claimed is:

1. An information processing apparatus comprising:
a storage configured to store navigation-related information; and
a controller configured to execute:
predicting a course of a vehicle based on at least the navigation-related information, and
projecting a first image related to the predicted course onto a road surface located in front of the vehicle.

2. The information processing apparatus according to claim 1, wherein
when a change in the direction of travel of the vehicle within a predetermined period of time has been predicted, the controller projects the first image indicating the direction of travel after the change.

3. The information processing apparatus according to claim 1, wherein
the navigation-related information includes road map information, and
the controller performs the prediction based on the road map information.

4. The information processing apparatus according to claim 3, wherein
the controller is configured to perform the prediction also based on driving-related information acquired from the vehicle.

5. The information processing apparatus according to claim 4, wherein
the driving-related information includes information on a blinker status of the vehicle.

6. The information processing apparatus according to claim 1, wherein
the controller is configured to use a headlight unit that is mounted on the vehicle and capable of digital light processing to project the first image onto a predetermined projection position.

7. The information processing apparatus according to claim 6, wherein
the controller is configured to determine a projection angle of the first image with respect to the road surface so that the projection position is fixed independently of the travel of the vehicle.

8. The information processing apparatus according to claim 6, wherein
the first image is configured to notify in advance that the vehicle will make a right or left turn at an intersection, and
the controller is configured to determine a predetermined point within the intersection as the projection position.

9. The information processing apparatus according to claim 8, further comprising
a sensor unit configured to detect the presence of a pedestrian travelling in a direction intersecting the course of the vehicle, wherein
upon detection of the pedestrian, the controller projects a second image to notify the pedestrian of an intention to give way.

10. The information processing apparatus according to claim 9, wherein
before the second image is projected, the controller notifies a driver of the vehicle of this fact.

11. The information processing apparatus according to claim 9, wherein
the controller determines the orientation of the second image based on the direction of travel of the pedestrian.

12. The information processing apparatus according to claim 9, wherein
the first image includes a graphic, and the second image includes text.

13. The information processing apparatus according to claim 1, wherein
the navigation-related information includes road map information, and planned course information on the vehicle, and
the controller performs the prediction based on the road map information and the planned course information.

14. A vehicle comprising:
a projector configured to project an image on a road surface located in front of the vehicle;
a storage configured to store navigation-related information; and
a controller configured to execute:
predicting a course of a vehicle based on at least the navigation-related information, and
projecting a first image related to the predicted course through the projector.

15. The vehicle according to claim 14, wherein
when a change in the direction of travel of the vehicle within a predetermined period of time has been predicted, the controller projects the first image indicating the direction of travel after the change.

16. The vehicle according to claim 14, wherein
the navigation-related information includes road map information, and
the controller performs the prediction based on the road map information.

17. The vehicle according to claim 14, wherein
the controller is configured to determine a projection angle of the first image with respect to the road surface so that the projection position is fixed independently of the travel of the vehicle.

18. The vehicle according to claim 17, wherein
the first image is configured to notify in advance that the vehicle will make a right or left turn at an intersection, and
the controller is configured to determine a predetermined point within the intersection as the projection position.

19. The vehicle according to claim 18, further comprising
a sensor unit configured to detect the presence of a pedestrian travelling in a direction intersecting the course of the vehicle, wherein
upon detection of the pedestrian, the controller projects a second image to notify the pedestrian of an intention to give way.

20. The vehicle according to claim 19, wherein
the controller determines the orientation of the image based on the direction of travel of the pedestrian.
